(19) United States
(12) Patent Application Publication
(10) Pub. No.: US 2026/0154177 A1
(43) Pub. Date: Jun. 4, 2026

(54) INFORMATION PROCESSING DEVICE, INFORMATION PROCESSING METHOD, AND COMPUTER-READABLE MEDIUM

(71) Applicant: Panasonic Automotive Systems Co., Ltd., Kanagawa (JP)

(72) Inventors: Kosei YONEDA, Kanagawa Ken (JP); Yuma MATSUKI, Tokyo To (JP); Yuka INOUE, Tokyo To (JP); Hiroyuki HORII, Tokyo To (JP)

(73) Assignee: Panasonic Automotive Systems Co., Ltd., Kanagawa (JP)

(21) Appl. No.: 19/381,471

(22) Filed: Nov. 6, 2025

(30) Foreign Application Priority Data
Nov. 29, 2024 (JP) 2024-208550

(51) Int. Cl. G06F 11/34

(52) U.S. Cl. CPC G06F 11/3476

(57) ABSTRACT

An information processing device according to the present disclosure includes a memory, and a hardware processor coupled to the memory. The hardware processor is configured to: identify, from log information related to a plurality of log files, processing information of software indicated by each of the log files; generate visualized log information for visualizing the log information based on the identified processing information; assign, to the visualized log information, time interval information indicating a time interval to be visualized for each predetermined piece of the processing information; and output the visualized log information to a display device based on the time interval information.

### CROSS-REFERENCE TO RELATED APPLICATIONS

This application is based upon and claims the benefit of priority from Japanese Patent Application No. 2024-208550, filed on Nov. 29, 2024, the entire contents of which are incorporated herein by reference.

### FIELD

The present disclosure relates to an information processing device, an information processing method, and a computer-readable medium.

### BACKGROUND

Conventionally, there is a technique of interpreting a character string of a log generated by execution of software, determining a visualization pattern on the basis of the content of the interpreted character string, and displaying visualized log information. For example, a software developer can grasp the state of the software from the visualized log information.

A related technique is described in JP 2017-224250 A.

However, in a related technique, since no method of visualizing the state for each piece of processing of software is explicitly described, it is necessary to identify a log and determine which processing state it is internally. In addition, there is no mention of changing the display time of the state or an instantaneous event, and thus it is difficult to grasp the timing of the instantaneous event. Therefore, in a case where the software developer performs failure analysis on the basis of log information, it may take time to identify the cause in the analysis of the log of only character information such as the text format.

For example, the software developer organizes time-series logs in identifying the cause from the log information, identifies logs before and after the time when the failure event occurs, and grasps and analyzes the internal processing before and after the time when the failure event occurs. Therefore, in a case where the above procedure is performed as it is from output log information, it takes time to identify the cause.

One of the problems to be solved by the present disclosure is to provide an information processing device, an information processing method, and an information processing program capable of easily grasping the state of software and improving the efficiency of analysis work.

### SUMMARY

An information processing device according to the present disclosure includes a memory, and a hardware processor coupled to the memory. The hardware processor is configured to: identify, from log information related to a plurality of log files, processing information of software indicated by each of the log files; generate visualized log information for visualizing the log information based on the identified processing information; assign, to the visualized log information, time interval information indicating a time interval to be visualized for each predetermined piece of the processing information; and output the visualized log information to a display device based on the time interval information.

### BRIEF DESCRIPTION OF THE DRAWINGS

FIG. 1 is a diagram illustrating an exemplary functional configuration of an information processing system according to an embodiment;

FIG. 2 is a schematic diagram illustrating an example of log information according to the embodiment;

FIG. 3 is a reference table for identifying processing information and unit-of-processing information of software according to the embodiment;

FIG. 4 is a timing chart for explaining the relationship between visualized log information and time interval information according to the embodiment;

FIG. 5 is a schematic diagram for explaining visualized log information to be output to a display device according to the embodiment;

FIG. 6 is a schematic diagram for explaining visualized log information to be output to the display device according to the embodiment;

FIG. 7 is a flowchart illustrating an example of a flow of processing executed by a log output device according to the embodiment;

FIG. 8 is a flowchart illustrating an example of a flow of processing executed by a visualization device according to the embodiment;

FIG. 9 is a flowchart illustrating an example of a flow of processing executed by the visualization device according to the embodiment;

FIG. 10 is a flowchart illustrating an example of a flow of processing executed by the visualization device according to the embodiment;

FIG. 11 is a schematic diagram for explaining visualized log information to be output to a display device according to a first modification;

FIG. 12 is a schematic diagram illustrating an example of log information according to a second modification;

FIG. 13 is a schematic diagram illustrating an example of visualized log information according to the second modification;

FIG. 14 is a reference table for identifying unit-of-processing information of software according to a third modification;

FIG. 15 is a schematic diagram illustrating an example of visualized log information according to the third modification; and

FIG. 16 is a diagram illustrating an example of the hardware configuration of the information processing system according to the embodiment and the modifications.

### DETAILED DESCRIPTION

Hereinafter, embodiments of an information processing device according to the present disclosure will be described with reference to the drawings. In the description of the present disclosure, components having the same or substantially the same functions as those described with respect to previously described drawings are denoted by the same reference numerals, and description thereof may be omitted as appropriate. In addition, even in the case of representing the same or substantially the same portion, dimensions or ratios may be represented differently from each other depending on drawings. Furthermore, for example, from the viewpoint of ensuring visibility of the drawings, in the description of each drawing, only major components are denoted by reference numerals, and even components having the same or substantially the same functions as those described in previous drawings may not be denoted by reference numerals.

In the description of the present disclosure, components having the same or substantially the same function may be distinguished from each other and described by adding alphanumeric characters to the end of reference numerals. Alternatively, in a case where a plurality of components having the same or substantially the same function are not distinguished from each other, the components may be described in an integrated manner by omitting alphanumeric characters added to the end of reference numerals.

### Embodiment

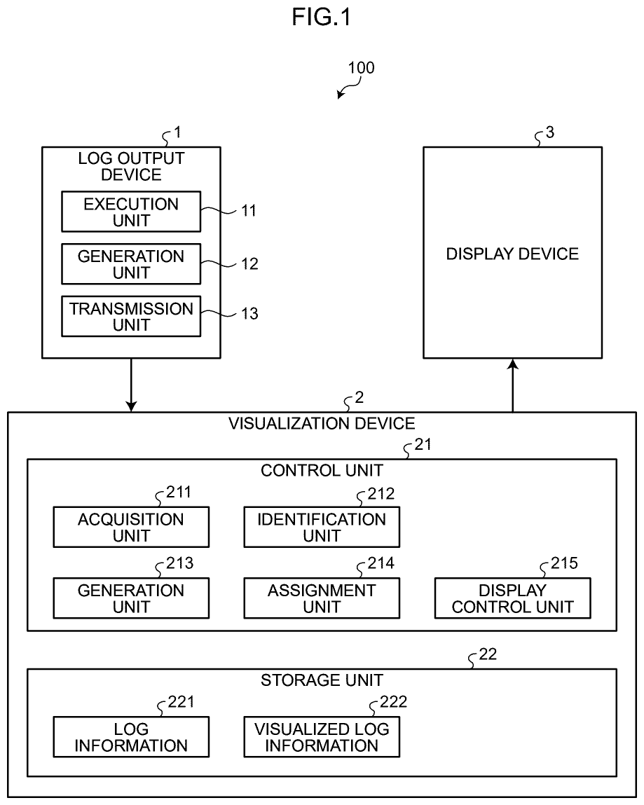

FIG. 1 is a diagram illustrating an exemplary functional configuration of an information processing system 100 according to an embodiment. As illustrated in FIG. 1, the information processing system 100 includes a log output device 1, a visualization device 2, and a display device 3. In the information processing system 100, the log output device 1, the visualization device 2, and the display device 3 are connected via a network (electric communication line) such as the Internet. Note that communication between the log output device 1, the visualization device 2, and the display device 3 may be performed via a dedicated communication line (electric communication line).

The log output device 1 is, for example, an in-vehicle information device mounted on a vehicle. For example, the log output device 1 executes software to be analyzed and generates log information corresponding to a result of the execution.

The visualization device 2 is, for example, at least one server device configured on the network such as the Internet. The visualization device 2 is an example of the information processing device. The visualization device 2 may further include another device such as a network storage (storage device). The visualization device 2 acquires the log information generated by the log output device 1 and generates visualization information to be output to the display device 3.

The display device 3 is, for example, a liquid crystal display. The display device 3 outputs the visualization information generated by the visualization device 2 in a visually recognizable manner.

Next, functions of the log output device 1, the visualization device 2, and the display device 3 will be described. The log output device 1 includes an execution unit 11, a generation unit 12, and a transmission unit 13.

The execution unit 11 executes the software to be analyzed. The software to be analyzed is, for example, a software program for performing audio reproduction or vehicle control in a vehicle.

The generation unit 12 generates a log file corresponding to a processing result obtained by executing the software to be analyzed. Specifically, the generation unit 12 generates a log file corresponding to a processing result of the software to be analyzed executed by the execution unit 11. The log file includes an event ID, a time stamp, a processing target, the processing content, a processing result, and the like. The generation unit 12 stores the generated log file in the storage unit. The storage unit is, for example, a memory.

The event ID is an ID of an event at the time when the software is processed. The time stamp is time information including the time when the software is processed. The format of the type stamp is, for example, in hours, minutes, seconds, and milliseconds (hh:mm:ss.sss). The processing target is, for example, the name of a resource on which the software processing has been performed. The processing content is, for example, the content of software processing. The processing result is, for example, the result of performing the software processing (such as a success, a failure, or others).

The transmission unit 13 transmits log information regarding a plurality of log files to the visualization device 2. Specifically, the transmission unit 13 transmits the log information regarding the plurality of log files generated by the generation unit 12 to the visualization device 2.

The visualization device 2 includes a control unit 21 and a storage unit 22. The visualization device 2 is an example of the information processing device. The control unit 21 is configured as, for example, a central processing unit (CPU) and integrally controls the operation of each unit of the visualization device 2. The visualization device 2 according to the present embodiment includes a read only memory (ROM) and a random access memory (RAM) (not illustrated). The ROM stores various programs. The RAM serves as a work area at the time when the CPU executes a program. The visualization device 2 includes, for example, a processor and a memory, and the processor executes a program stored in the memory, thereby implementing the functions of functional blocks included in the control unit 21 and the control unit 21. The CPU is an example of the processor. The storage unit 22 is an example of the memory.

The CPU executes a program stored in the ROM by using the RAM as a work area, thereby implementing an acquisition unit 211, an identification unit 212, a generation unit 213, an assignment unit 214, and a display control unit 215. This may be rephrased as that the visualization device 2 includes the acquisition unit 211, the identification unit 212, the generation unit 213, the assignment unit 214, and the display control unit 215. The acquisition unit 211, the identification unit 212, the generation unit 213, the assignment unit 214, and the display control unit 215 may be implemented by different pieces of hardware.

The storage unit 22 stores log information 221 output from the log output device 1 and visualized log information 222 generated by the visualization device 2. The log information 221 and the visualized log information 222 will be described later. Note that information stored in the storage unit 22 is not limited to the above.

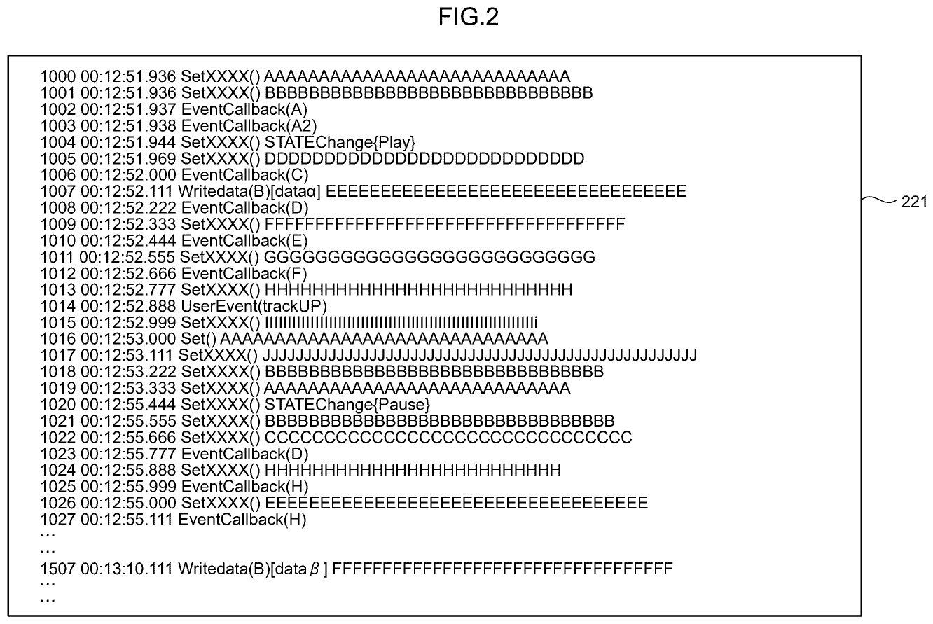

The acquisition unit 211 acquires the log information 221. Specifically, the acquisition unit 211 acquires the log information 221 related to a plurality of log files transmitted by the log output device 1. In addition, the acquisition unit 211 arranges the acquired log information 221 in chronological order. Then, the acquisition unit 211 stores the log information 221 arranged in chronological order in the storage unit 22. The log information 221 will be described with reference to FIG. 2.

FIG. 2 is a schematic diagram illustrating an example of the log information 221 according to the embodiment. In the log information 221 illustrated in FIG. 2, character strings of log files are arranged in chronological order. The format of the log information 221 illustrated in FIG. 2 includes, for example, the event ID indicating an identifier for tracing a series of events, the time stamp regarding the time when an event has occurred, and the processing information regarding software processing in the order mentioned. Note that the format of the log files of the log information 221 (output format of the log files) is not limited thereto. Note that the “character string” described herein includes that converted from binary data in such a manner that a human, such as a software developer, can interpret in a case where a log is output as the binary data or the like. A character string is also referred to as a text or text data.

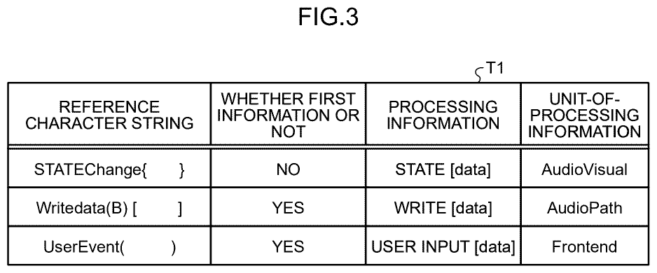

Referring back to FIG. 1, the description will be continued. The identification unit 212 identifies processing information of the software from the information of the plurality of log files. Specifically, the identification unit 212 identifies processing information and unit-of-processing information of the software from the log information 221 related to the plurality of log files acquired by the acquisition unit 211. The processing information of the software is, for example, various states of the system, user control, and the like. The unit-of-processing information of the software is, for example, information including the name of a process executed by the CPU and a unit of processing which is a unit of each process executed by the CPU. For example, the identification unit 212 identifies the processing information and the unit-of-processing information from the log information 221 on the basis of reference information including a reference character string related to the processing of the software to be visualized. The content of the processing in which the identification unit 212 identifies the processing information of the software from the log information 221 will be described with reference to FIG. 3.

FIG. 3 is a reference table for identifying the processing information and the unit-of-processing information of the software according to the embodiment. The reference table is an example of reference information including a reference character string related to the processing of the software to be visualized, and the granularity of the processing information may also be subdivided into such a fashion as “state of xxx”, “state of yyy”, and the like. The reference table T1 illustrated in FIG. 3 is information in which, for example, a reference character string related to processing of software, an item related to whether or not each piece of processing information is first information indicating an event that occurs instantaneously, processing information related to processing of the software, and unit-of-processing information related to units of processing of the software are associated with each other. In the present embodiment, a reference character string related to the processing of the software illustrated in FIG. 3 corresponds to the processing information and the unit-of-processing information of the software to be visualized which is described later.

The first information includes, for example, data writing, memory allocation, network connection, user input notification, and the like in software processing. Note that the first information is not limited to the above. For example, in a case where the character string of a log file is “STATEChange{ }”, whether or not the information is the first information is “No”, the processing information is “state (data)”, and the unit-of-processing information is “AudioVisual”. In addition, for example, in a case where the character string of a log file is “Writedata(B)( )”, whether or not the information is the first information is “YES”, the processing information is “write(data)”, and the unit-of-processing information is “AudioPath”.

Moreover, for example, in a case where the character string of a log file is “UserEvent( )”, whether or not the information is the first information is “YES”, the processing information is “user input (data)”, and the unit-of-processing information is “Frontend”. Note that the reference table T1 is not limited to the above, and the unit-of-processing information may not be identified from the reference character string. For example, the unit-of-processing information may be identified from the file name of log files.

Referring back to FIG. 1, the description will be continued. The generation unit 213 generates the visualized log information 222 for visualizing the log information 221 on the basis of the reference table T1 in FIG. 3. Specifically, the generation unit 213 generates the visualized log information 222 for visualizing the log information 221 on the basis of the processing information of the software identified by the identification unit 212.

For example, the generation unit 213 generates, from the log information 221 arranged in chronological order by the acquisition unit 211, the visualized log information 222 in which the identification unit 212 visualizes the log information 221 on the basis of the reference table T1 in FIG. 3. In addition, the generation unit 213 adds the processing information of the software identified by the identification unit 212 to the visualized log information 222. Then, the generation unit 213 adds the processing information of the software and stores the generated visualized log information 222 including the processing information of the software in the storage unit 22.

The assignment unit 214 assigns time interval information indicating a time interval to be visualized for each predetermined piece of processing information to the visualized log information 222. Specifically, the assignment unit 214 assigns, to the visualized log information 222 generated by the generation unit 213, the time interval information indicating a time interval to be visualized for each piece of processing information of the software, the time interval information to be included in the predetermined piece of processing information of the software.

First, the assignment unit 214 identifies whether or not each piece of processing information of the software includes the first information indicating an instantaneous event in the visualized log information 222. For example, the assignment unit 214 refers to an item related to whether or not each piece of processing information of the software illustrated in the reference table T1 of FIG. 3 is the first information indicating an event that occurs instantaneously, and in a case where the first information is included in the log information of the visualized log information 222 with respect to the visualized log information 222, the assignment unit 214 identifies that the log information is the first information.

Alternatively, for example, the assignment unit 214 refers to an item related to whether or not the processing information of the software illustrated in the reference table T1 of FIG. 3 is the first information indicating an event that occurs instantaneously, and in a case where no first information is included in the log information of the visualized log information 222 with respect to the visualized log information 222, the assignment unit 214 identifies that the log information is second information. The second information includes, for example, an audio reproduction state, an operation state of an application including activation, execution, termination, and the like of the application, a connection state of a device including states of being connected, disconnected, or not yet connected, and the like of the device, and others. Note that the second information is not limited to the above. The first information and the second information are also collectively referred to as the state of the software.

Then, in a case where the reference table T1 illustrated in FIG. 3 is referred to in the visualized log information 222 and the first information indicating an event that occurs instantaneously is included in each piece of processing information of the software in the log information of the visualized log information 222, the assignment unit 214 assigns time interval information indicating a time interval longer than the time during which the first information has occurred. In this example, in a case where the time during which the first information has occurred is denoted as T (sec), a time interval longer than the time during which the first information has occurred is T+t (sec). For example, t (sec) is 2 (sec). Note that the time interval longer than the time during which the first information has occurred can be set by the processing information of the software or the user as appropriate.

Furthermore, in a case where the visualized log information 222 does not include the first information and refers to the reference table T1 illustrated in FIG. 3 and the second information indicating an event that occurs continuously is included in each piece of processing information of the software in the log information of the visualized log information 222, the assignment unit 214 assigns time interval information indicating a time interval in which the second information has occurred.

In this example, the reason the assignment unit 214 assigns different time interval information to the first information and the second information is that, for example, in a case where the user performs analysis work of log files of the software, in order to identify the first information that is an event that occurs instantaneously, it is necessary to identify an instantaneous time in the event in each piece of processing information of the software. However, there is a case where it is difficult for the user to identify the instantaneous time due to the fact that a large amount of character strings of log files are output or due to limited information of character information such as a text format or the like.

Therefore, in the present embodiment, in a case where the first information indicating an event that instantaneously occurs in the processing information of the software is included, the time interval information indicating a time interval longer than the time during which the first information has occurred is assigned.

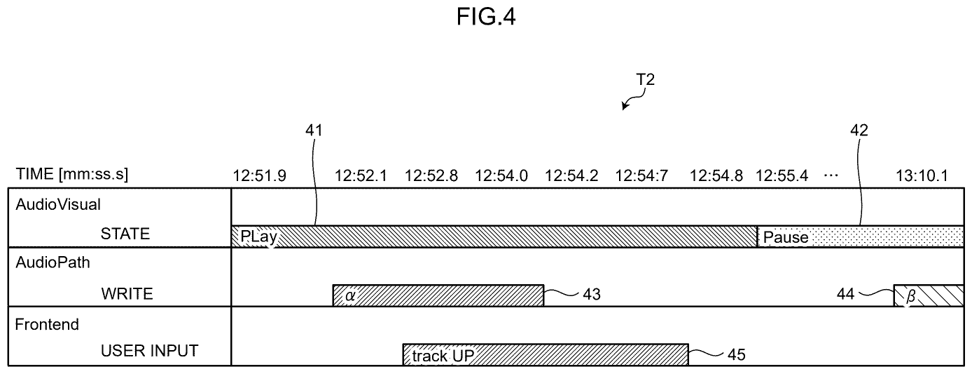

Furthermore, the assignment unit 214 stores the time interval information assigned to the visualized log information 222 in the storage unit 22 in association with the visualized log information 222. The assignment unit 214 performs the above-described processing on the log information of the visualized log information 222. The relationship between the visualized log information 222 and the time interval information will be described with reference to FIG. 4.

FIG. 4 is a timing chart for explaining the relationship between the visualized log information 222 and the time interval information according to the embodiment. A timing chart T2 illustrated in FIG. 4 is a schematic diagram in which time (mm:ss.s), unit-of-processing information, and processing information are associated with each other.

For example, the processing information “State” of the unit-of-processing information “AudioVisual” indicates a processing time 41 corresponding to (Play) and a processing time 42 corresponding to (Pause) for (Play) and (Pause) of continuously occurring events (states), respectively, identified from a character string (STATEChange) of the log information 221. Meanwhile, for example, the processing information “Write” of the unit-of-processing information “AudioPath” indicates a processing time 43 corresponding to (α) and a processing time 44 corresponding to (β) for (α) and (β) of instantaneously occurring events (Write), respectively, identified from a character string (Writedata) of the log information 221.

Furthermore, for example, regarding the processing information “User Input” of the unit-of-processing information “Frontend”, a processing time 45 corresponding to (trackUP) is indicated for (trackUP) of the instantaneously occurring event (User Input) that is identified from the character string (UserEvent) of the log information 221. As a result, the visualization device 2 can generate the visualized log information 222 that allows the user to easily grasp the state of the software when performing the analysis work by assigning the time interval information to the visualized log information 222 in accordance with the processing information of the software.

Referring back to FIG. 1, the description will be continued. The display control unit 215 outputs the log information of the visualized log information 222 to the display device 3 for each piece of processing information of the software on the basis of the time interval information. Specifically, the display control unit 215 outputs the log information of the visualized log information 222 to the display device 3 on the basis of the time interval information assigned to the visualized log information 222 by the assignment unit 214. In addition, the display control unit 215 outputs the visualized log information 222 to the display device 3 together with the processing information. Furthermore, the visualized log information 222 includes the state of the software and a text log.

For example, the display control unit 215 reads the time and the character string of the visualized log information 222 to be included in the time interval information assigned to the visualized log information 222 by the assignment unit 214. Then, the display control unit 215 outputs the time and the character string of the visualized log information 222 to the display device 3 for each piece of processing information of the software. The display control unit 215 outputs the time at the head of the log information 221 or the visualized log information 222 to the display device 3 in an initial state, specifically, in a state where the user has not input the time.

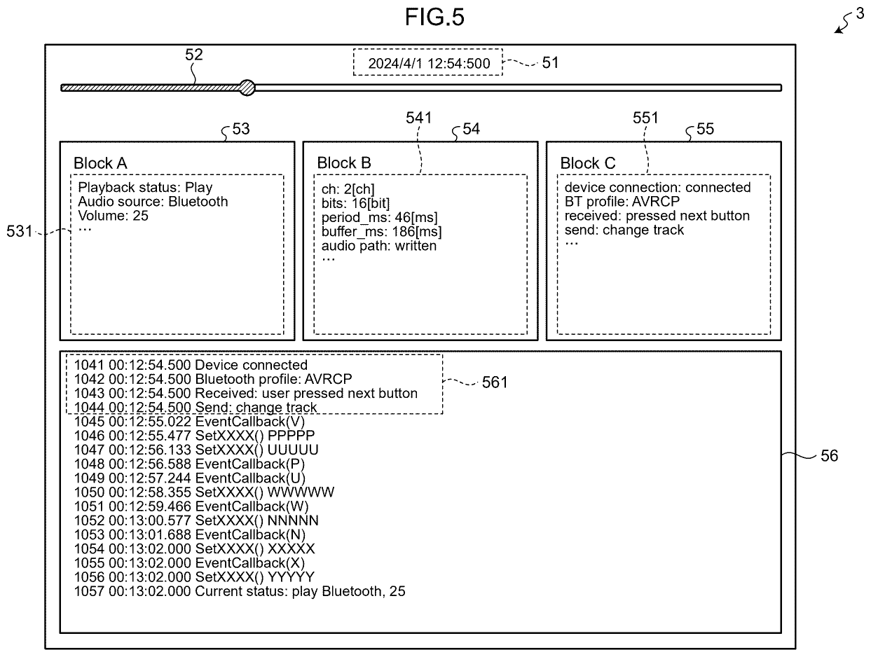

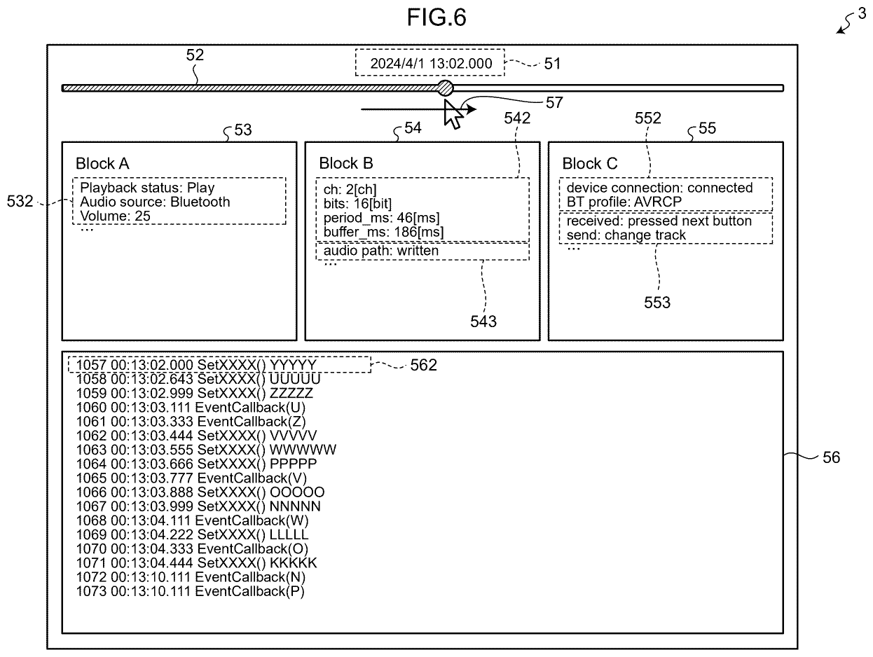

In addition, the display control unit 215 reads the time and the character string of the log information 221 acquired by the acquisition unit 211 and outputs the read time and character string of the log information 221 to the display device 3. Furthermore, the display control unit 215 outputs, to the display device 3, a time operation section by which the user operates the time of the log information 221 on the basis of the time of the log information 221. In this example, the visualized log information 222 output from the display control unit 215 to the display device 3 will be described with reference to FIGS. 5 and 6.

FIG. 5 is a schematic diagram for explaining the visualized log information 222 to be output to the display device 3 according to the embodiment. The display device 3 illustrated in FIG. 5 outputs a time display area 51 in which the time input by the user is displayed, a time operation section 52 in which the user operates the time in the time display area 51, and a first display area 53, a second display area 54, a third display area 55, and a fourth display area 56 each indicating a display area in which the log information 221 corresponding to the time in the time display area 51 is displayed. The time display area 51 is output above the first display area 53, the second display area 54, and the third display area 55. Note that the time herein represents a time stamp in a log and thus may be replaced with, for example, a system time or the like after the log output device 1 is activated.

The first display area 53, the second display area 54, and the third display area 55 illustrated in FIG. 5 display the visualized log information 222 corresponding to the time in the time display area 51 for each piece of processing information of the software. For example, in the first display area 53, information regarding (Play) of a continuously occurring event (state) is output to a first log 531.

In the second display area 54, information regarding (written) of an instantaneously occurring event (Write) is output to a second log 541. In the third display area 55, information related to (pressed next button) of an instantaneously occurring event (User Input) is output to a third log 551.

The fourth display area 56 illustrated in FIG. 5 displays log files of the log information 221. For example, in the fourth display area 56, a fourth log 561 of the log information 221 including a first log 531, a second log 541, and a third log 551 of the visualized log information 222 is output.

FIG. 6 is a schematic diagram for explaining the visualized log information 222 to be output to the display device 3 according to the embodiment. As illustrated in FIG. 6, the display control unit 215 indicates the content of outputting a character string of the visualized log information 222 corresponding to an input time to the display device 3 for each piece of processing information of the software corresponding to the input time obtained with the user operating the time operation section 52 illustrated in FIG. 6 along an arrow 57. For example, the display control unit 215 acquires position information regarding the position of the time operation section 52 operated by the user. The display control unit 215 also identifies an input time corresponding to the position information of the time operation section 52. Then, the display control unit 215 outputs the visualized log information 222 corresponding to the identified input time to the display device 3.

For example, while checking the visualized log information 222 output to the first display area 53, the second display area 54, and the third display area 55, the user operates the time operation section 52 along the arrow 57 and changes the input time from a time of “2024 Apr. 1 12:54.500” (see the time display area 51 in FIG. 5) to a time of “2024 Apr. 1 13:02.000” (see the time display area 51 in FIG. 6). That is, in the first display area 53, the second display area 54, and the third display area 55, the visualized log information 222 is output in synchronization with the input time input by the user.

Then, as a result of the user operating the time operation section 52, the fourth display area 56 illustrated in FIG. 6 shows a fourth log 562 of the log information 221. In addition, since a first log 532 in the first display area 53, a second log 542 in the second display area 54, and a third log 552 in the third display area 55, which are output by the display control unit 215, have content indicating a state transition in the processing of the software, display control is performed in such a manner as to display the logs until a next state transition in the processing of the software occurs.

For example, at the time “2024 Apr. 1 13:02.000” (see the time display area 51 in FIG. 6) corresponding to the fourth log 562, since there was no state transition in the processing of the software from the time “2024 Apr. 1 12:54.500” (see the time display area 51 in FIG. 5), the first display area 53 illustrated in FIG. 6 shows the first log 532 of the visualized log information 222. Similarly, the second display area 54 shows the second log 542 and a second log 543 of the visualized log information 222.

Similarly, the third display area 55 shows the third log 552 and a third log 553 of the visualized log information 222. Note that the first log 532, the second log 542, and the third log 552 represent processing information (state) that continuously occurs, and the second log 543 and the third log 553 represent processing information that instantaneously occurs. That is, the visualized log information 222 includes the state of the software and a text log.

As a result, the visualization device 2 can output the visualized log information 222 to the display device 3 for each piece of processing information of the software. Therefore, the user such as a software developer can easily grasp the state of the software by checking the output log files to improve the efficiency of the analysis work.

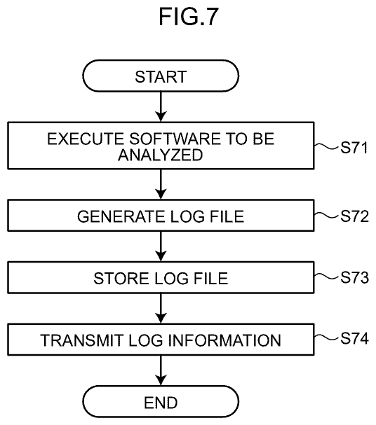

Next, a flow of processing executed by the information processing system 100 will be described with reference to FIGS. 7, 8, 9, and 10.

FIG. 7 is a flowchart illustrating an example of the flow of processing executed by the log output device 1 according to the embodiment. The execution unit 11 executes software to be analyzed (step S71). Subsequently, the generation unit 12 generates a log file corresponding to processing result of the software to be analyzed executed by the execution unit 11 (step S72). Then, the generation unit 12 stores the generated log file in the storage unit (step S73). Next, the transmission unit 13 transmits the log information 221 related to the plurality of log files generated by the generation unit 12 to the visualization device 2 (step S74). When the processing of step S74 ends, the present processing executed by the log output device 1 ends.

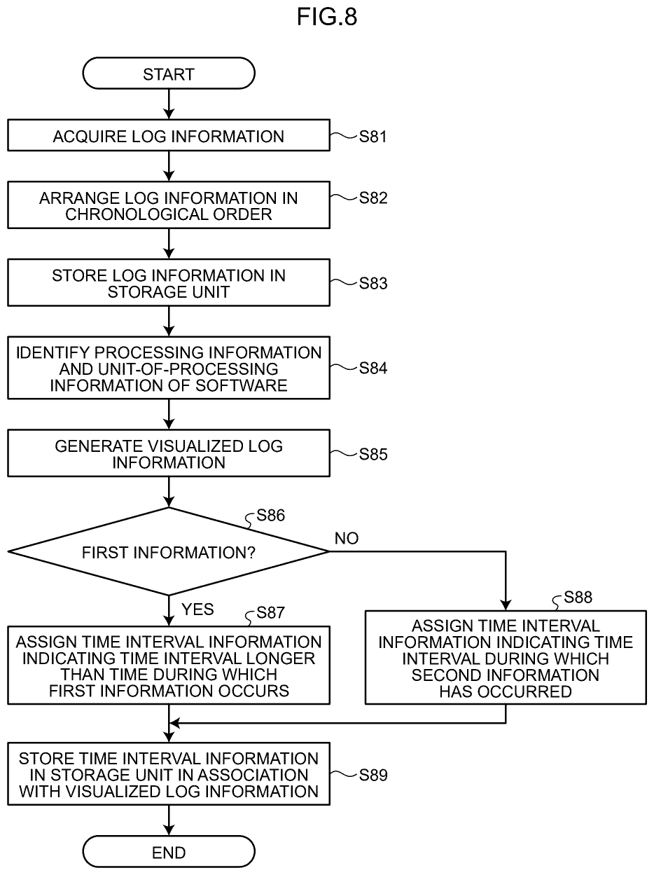

FIGS. 8, 9, and 10 are flowcharts illustrating an example of the flow of processing executed by the visualization device 2 according to the embodiment. It is based on the premise that the flowchart illustrated in FIG. 8 is started after the processing of step S74 illustrated in FIG. 7 is completed.

The acquisition unit 211 acquires the log information 221 related to the plurality of log files transmitted by the log output device 1 (step S81). Subsequently, the acquisition unit 211 arranges the acquired log information 221 in chronological order (step S82). The acquisition unit 211 stores the log information 221 arranged in chronological order in the storage unit 22 (step S83). Subsequently, the identification unit 212 identifies the processing information of the software on the basis of the reference table T1 from the log information 221 related to the plurality of log files acquired by the acquisition unit 211 (step S84).

Subsequently, the generation unit 213 generates the visualized log information 222 for visualizing the log information 221 on the basis of the processing information of the software identified by the identification unit 212 (step S85). Then, the assignment unit 214 identifies whether or not each piece of processing information of the software included in the visualized log information 222 includes the first information indicating an event that occurs instantaneously (step S86). If the assignment unit 214 identifies here that no first information is included in the visualized log information 222 (step S86: No), the processing proceeds to step S88. On the other hand, if the assignment unit 214 identifies that the visualized log information 222 includes the first information (step S86: Yes), the processing proceeds to step S87.

In step S87, if the first information indicating an instantaneously occurring event in the processing information of the software included in the visualized log information 222 is included, the assignment unit 214 assigns time interval information indicating a time interval longer than the time during which the first information has occurred to the visualized log information 222 (step S87). In step S88, if no first information is included, the assignment unit 214 assigns, to the visualized log information 222, time interval information indicating a time interval in which the second information has occurred (step S88). Note that, in the present identification, not including the first information and including the second information are synonymous.

In step S89, the assignment unit 214 associates the time interval information assigned to the visualized log information 222 with the visualized log information 222 and stores the associated time interval information in the storage unit 22 (step S89). When the processing of step S89 ends, the present processing executed by the visualization device 2 ends.

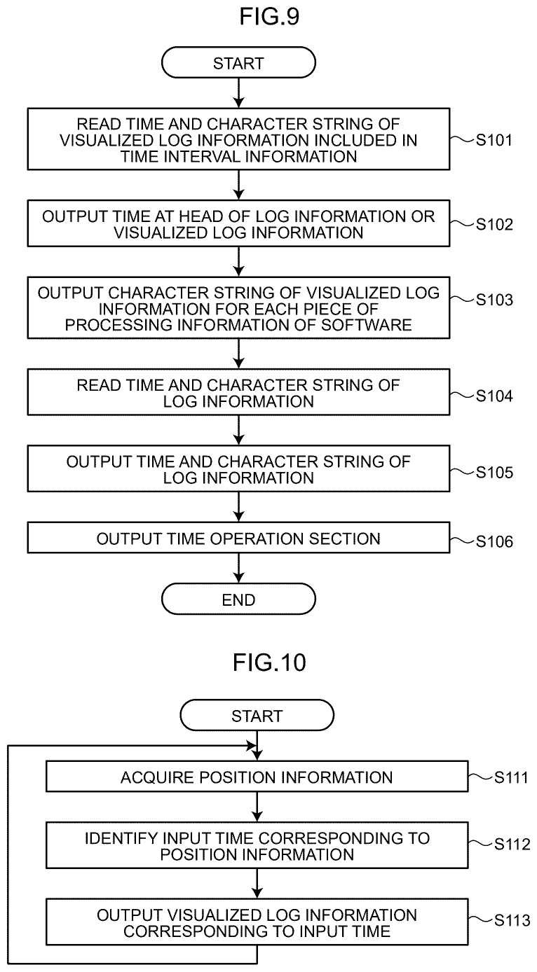

It is based on the premise that the flowchart illustrated in FIG. 9 is started after the processing of step S89 illustrated in FIG. 8 is completed. The display control unit 215 reads the time and character strings of the visualized log information 222 included in the time interval information assigned to the visualized log information 222 by the assignment unit 214 (step S101). Subsequently, the display control unit 215 outputs the time at the head of the log information 221 or the visualized log information 222 to the display device 3 (step S102).

Subsequently, the display control unit 215 outputs the character strings of the visualized log information 222 to the display device 3 for each piece of processing information of the software (step S103). Then, the display control unit 215 reads the time and character strings of the log information 221 acquired by the acquisition unit 211 (step S104). Subsequently, the display control unit 215 outputs the time and the character strings of the read log information 221 to the display device 3 (step S105).

Subsequently, on the basis of the time of the log information 221, the display control unit 215 outputs the time operation section 52 by which the user operates the time of the log information 221 to the display device 3 (step S106). When the processing of step S106 ends, the present processing executed by the visualization device 2 ends.

It is based on the premise that the flowchart illustrated in FIG. 10 is started after the processing of step S106 illustrated in FIG. 9 is completed. The display control unit 215 acquires position information regarding the position of the time operation section 52 operated by the user (step S111). Subsequently, the display control unit 215 identifies the input time corresponding to the position information of the time operation section 52 (step S112). Then, the display control unit 215 outputs the visualized log information 222 corresponding to the identified input time to the display device 3 (step S113). When the processing of step S113 ends, the processing proceeds to step S111, and the present processing is continuously performed while the visualization device 2 is being executed.

As described above, the visualization device 2 according to one aspect of the present disclosure identifies, from the log information 221 related to the plurality of log files, the processing information of the software indicated by each of the log files and generates the visualized log information 222 for visualizing the log information 221 on the basis of the identified processing information. Then, the visualization device 2 assigns the time interval information indicating a time interval to be visualized for each predetermined piece of processing information to the visualized log information 222 and outputs the visualized log information 222 to the display device 3 on the basis of the time interval information.

For example, the visualization device 2 outputs the visualized log information 222 to the display device 3 for each piece of processing information of the software. As a result, the user such as a software developer can easily grasp the state of the software by checking the output log files to improve the efficiency of the analysis work.

Moreover, in a case where the first information indicating an event that occurs instantaneously is included in each piece of processing information of the software in the visualized log information 222, the visualization device 2 assigns the time interval information indicating a time interval longer than the time during which the first information has occurred. Furthermore, in a case where the second information indicating an event that occurs continuously is included in each piece of processing information of the software in the visualized log information 222, the visualization device 2 assigns the time interval information indicating the time interval longer which the second information has occurred.

As a result, even in a case where it is difficult to identify an instantaneous time of processing of the software due to output of a large number of character strings of the log files or limited information of only the character information in a text format or the like, the user can easily grasp the state of the software since the visualization device 2 outputs a time interval set to be long from the instantaneous time of processing of the software.

Furthermore, the visualization device 2 outputs, depending on input time input from the user, the visualized log information 222 corresponding to the input time to the display device 3 for each piece of processing information. By checking the output log file corresponding to the input time that is input, the user can easily grasp the state of the software to improve the efficiency of the analysis work.

Note that the above-described embodiment can be implemented with modification as appropriate by changing a part of the configuration or the function of each of the above-described devices. Therefore, in the following, some modifications according to the above-described embodiment will be described as other embodiments. In the following description, points different from the above-described embodiment will be mainly described, and detailed description of points common to the content already described will be omitted.

### First Modification

For example, the display control unit 215 may output, to the display device 3, a plurality of time operation sections for a user to operate the time of the log information 221.

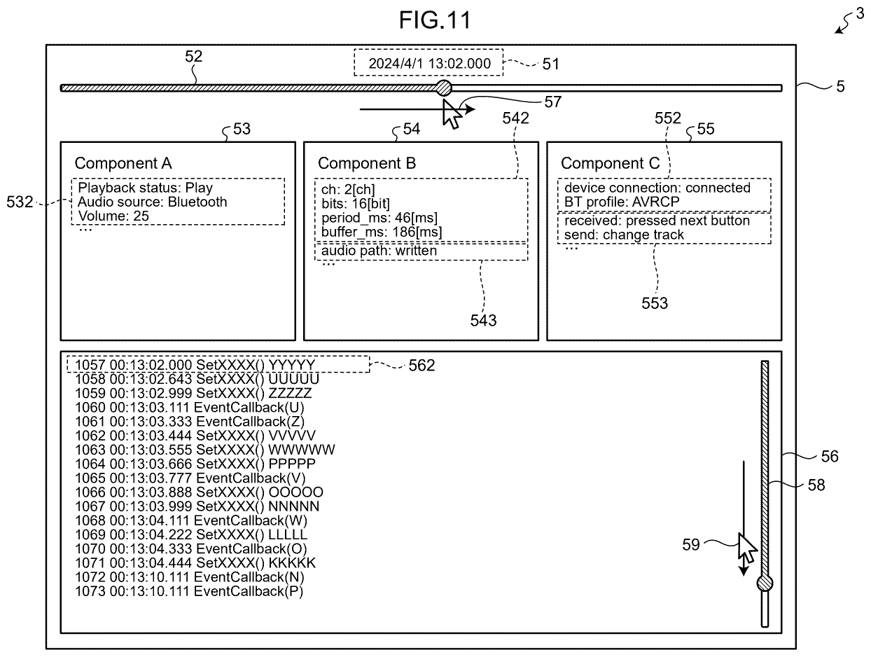

FIG. 11 is a schematic diagram for explaining the visualized log information 222 to be output to a display device 3 according to a first modification. The content of the display device 3 illustrated in FIG. 11 is obtained by outputting, to that in FIG. 6, a text scroll operation section 58 for the user to scroll texts of the log information 221. The text scroll operation section 58 is output while superimposed on the fourth display area 56.

For example, the user operates the text scroll operation section 58 along an arrow 59 while checking log files of the log information 221 output to the fourth display area 56 and changes the input time from the time “2024 Apr. 1 12:54.500” (see the time display area 51 in FIG. 5) to the time “2024 Apr. 1 13:02.000” (see the time display area 51 in FIG. 11). Then, the display control unit 215 updates the state of the software and the text log included in the visualized log information 222 simultaneously corresponding to the input time. Note that the text scroll operation section 58 is also referred to as a time operation section.

As a result, a user such as a software developer can check the processing state of the software while checking the log files of the log information 221. Therefore, the user can easily grasp the state of the software by checking the output log files to improve the efficiency of the analysis work.

### Second Modification

For example, the visualization device 2 may identify the processing information of the software from the log information 221 on the basis of the output format of a log file. With the log output device 1 implementing a code for incorporating a label into a log file, the visualization device 2 identifies processing information of the software from the log information 221 on the basis of the output format of the log file.

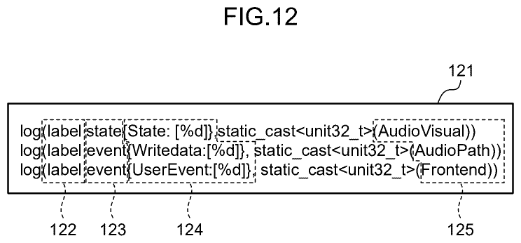

FIG. 12 is a schematic diagram illustrating an example of log information according to a second modification. In log information 121 illustrated in FIG. 12, a plurality of log files are aligned. The format of the log file of the log information 121 illustrated in FIG. 12 includes, for example, reference character string information 122 indicating a reference character string to be visualized, an item 123 regarding whether or not the information is the first information indicating an event that instantaneously occurs in processing information of the software, processing information 124 of the software, and unit-of-processing information 125 regarding the unit of processing of the software.

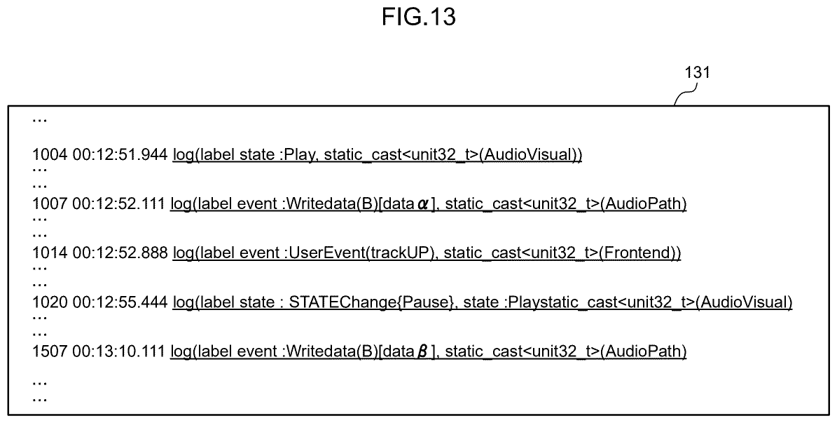

For example, in a case where a log file of the log information 121 includes (label) of the reference character string information 122, the identification unit 212 identifies that the processing information of the software is to be visualized. Then, the generation unit 213 generates the visualized log information in FIG. 13 on the basis of the unit of processing.

FIG. 13 is a schematic diagram illustrating an example of the visualized log information according to the second modification. The visualized log information 131 illustrated in FIG. 13 includes an event ID indicating an identifier for tracing a series of events, a time stamp regarding the time when an event has occurred, the reference character string information 122 indicating a reference character string to be visualized, the item 123 relating to whether or not the information is the first information indicating an instantaneously occurring event in the processing information of the software, the processing information 124 of the software, and the unit-of-processing information 125 relating to units of processing of the software in the order mentioned.

In addition, for example, in the visualized log information 131 including (label) (see FIG. 12) of the identified reference character string information 122, in a case where the item 123 related to whether or not the information is the first information indicating an event that occurs instantaneously is (State), the assignment unit 214 identifies that the information is the second information indicating an event that occurs continuously and assigns the time interval information indicating the time interval in which the second information has occurred to each piece of processing information of the software. In addition, in the visualized log information 131 including (label) (see FIG. 12) of the identified reference character string information 122, in a case where the item 123 related to whether or not the information is the first information indicating an event that occurs instantaneously is (Writedata) or (UserEvent), the assignment unit 214 identifies that the information is the first information indicating an event that occurs instantaneously and assigns the time interval information indicating the time interval longer than the time interval in which the first information has occurred to each piece of processing information of the software.

Thus, the visualization device 2 can generate the visualized log information 131 on the basis of the output format of a log file output by the log output device 1.

### Third Modification

For example, the visualization device 2 may identify the processing information of the software from the log information 221 on the basis of a predetermined character string included in a log file. The log output device 1 embeds an application ID and a context ID for identifying software, an application, or a group thereof in an extension header using diagnostic log and trace (DLT) whose specifications are defined by AUTOSAR with respect to a log file, and the visualization device 2 identifies the processing information of the software by one of these IDs or by combining both IDs.

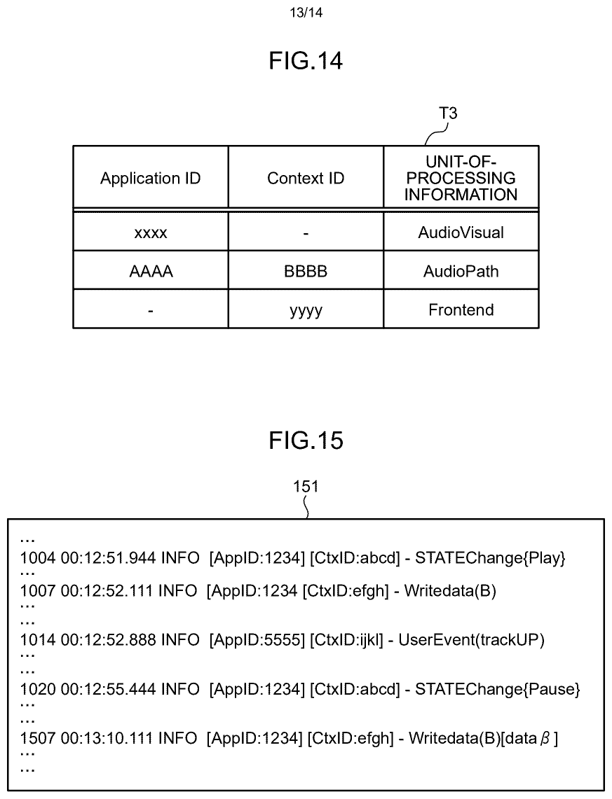

FIG. 14 is a reference table for identifying the unit-of-processing information of the software according to a third modification. A reference table T3 illustrated in FIG. 14 shows information in which the Application ID, the Context ID, and the unit-of-processing information are associated with each other.

For example, in the reference table T3, in a case where Application ID includes only a desired character string of “xxxx”, the unit-of-processing information is “AudioVisual”. Meanwhile, in a case where a desired character string of “AAAA” is included in the Application ID and a desired character string of “BBBB” is included in the Context ID, the unit-of-processing information is “AudioPath”. Alternatively, in a case where only a desired character string of “yyyy” is included in the Context ID, the unit-of-processing information is “Frontend”. Note that the reference table T1 is not limited to the above and is set as appropriate depending on units of processing of the software.

For example, in a case where there is a combination of the Application ID and the Context ID illustrated in FIG. 14 in the log files of the log information 121, the identification unit 212 identifies unit-of-processing information to be visualized. Then, the generation unit 213 generates the visualized log information illustrated in FIG. 15 based on the unit-of-processing information.

FIG. 15 is a schematic diagram illustrating an example of the visualized log information according to the third modification. In the visualized log information 151 illustrated in FIG. 15, a plurality of log files are aligned. The format of a log file of the visualized log information 151 illustrated in FIG. 15 includes an event ID indicating an identifier for tracing a series of events, a time stamp regarding the time when an event has occurred, an AppID indicating the Application ID, a CtxID indicating the Context ID, and a reference character string of the log file.

For example, the assignment unit 214 identifies the unit-of-processing information by using the Application ID and the Context ID of a log file of the visualized log information 151. Thus, the visualization device 2 can generate the visualized log information 151 on the basis of a predetermined character string included in a log file output by the log output device 1.

### Fourth Modification

For example, the visualization device 2 may include the functional configuration of the log output device 1. The visualization device 2 may also include the display device 3. Hardware Configuration

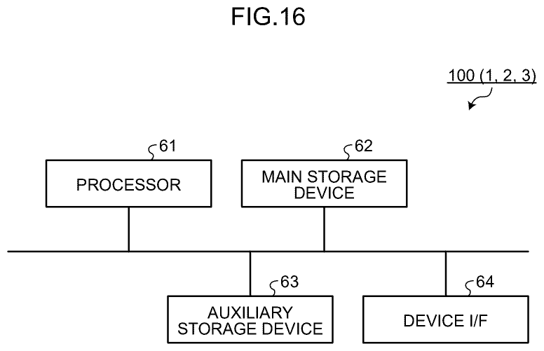

FIG. 16 is a diagram illustrating an example of the hardware configuration of the information processing system 100 according to the embodiment and the modifications.

In the log output device 1, the visualization device 2, and the display device 3 of the information processing system 100 of the above embodiment and the modifications, a processor 61, a main storage device 62, an auxiliary storage device 63, and a device I/F 64 are mutually connected by a bus or the like and have a hardware configuration using a normal computer.

The processor 61 is, for example, a CPU, and is an arithmetic device that controls the log output device 1, the visualization device 2, and the display device 3 of the above embodiment and the modifications. The main storage device 62 is, for example, a RAM and stores data necessary for various types of processing by the processor 61. The auxiliary storage device 63 is, for example, a ROM and stores a program or the like that implements information processing by the processor 61.

The device I/F 64 is an interface for various types of input and output and/or communication of the log output device 1, the visualization device 2, and the display device 3. For example, the device I/F 64 may include an output interface configured to be connectable to an external output device that outputs audio, an image, or a video or to function as the output device. As the output device, various displays (display members) such as a liquid crystal display (LCD), an organic electro-luminescence (EL) display, or a projector, a speaker, and the like can be used as appropriate.

For example, the device I/F 64 may include an input interface configured to be connectable to an external input device that acquires a user operation or to function as the input device. As the input device, a keyboard, a mouse, a touch panel, a microphone, or the like can be used as appropriate. For example, the device I/F 64 may include a communication interface configured to be connectable to an external communication device that communicates with the log output device 1, the visualization device 2, and the display device 3 or to function as the communication device.

As the communication interface, a communication circuit for wired communication such as the universal serial bus (USB) (registered trademark) or Ethernet (registered trademark) or a communication circuit for wireless communication supporting various standards such as 3G, LTE, 4G, 5G, 6G, Wi-Fi (registered trademark), or Bluetooth (registered trademark) can be used as appropriate. In a case where the log output device 1 and the visualization device 2 each include an independent USB interface, a log file may be stored in an external storage medium such as a USB memory from the log output device 1, and the external storage medium may be connected to the visualization device 2 to cause the visualization device 2 to read the log file.

In the log output device 1, the visualization device 2, and the display device 3 according to the above embodiment and the modifications, the processor 61 reads a program from the auxiliary storage device 63 onto the main storage device 62 and executes the program, whereby each of the above functional units is implemented on the computer.

The program for executing the above-described processing executed by the log output device 1, the visualization device 2, and the display device 3 according to the above-described embodiment and the modifications may be stored in a hard disk drive (HDD). Alternatively, the program for executing the above-described processing executed by the log output device 1, the visualization device 2, and the display device 3 according to the above-described embodiment and the modifications may be provided by being incorporated in the auxiliary storage device 63 in advance.

Further alternatively, the program for executing the above-described processing executed by the log output device 1, the visualization device 2, and the display device 3 according to the above-described embodiment and the modifications may be provided by being stored as a file in an installable format or an executable format in a computer-readable storage medium such as a CD-ROM, a CD-R, a memory card, a digital versatile disk (DVD), or a flexible disk (FD) and provided as a computer program product. Moreover, the program for executing the above-described information processing executed by the log output device 1, the visualization device 2, and the display device 3 according to the above-described embodiment and the modifications may be stored in a computer connected to a network such as the Internet and provided by being downloaded via the network. In addition, the program for executing the information processing executed by the log output device 1, the visualization device 2, and the display device 3 of the above-described embodiment and modification may be provided or distributed via a network such as the Internet.

According to at least one embodiment described above, it is possible to easily grasp the state of the software to improve the efficiency of analysis work.

According to the present disclosure, it is possible to easily grasp the state of software and to improve the efficiency of analysis work.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a memory; and
a hardware processor coupled to the memory, and configured to:
identify, from log information related to a plurality of log files, processing information of software indicated by each of the log files;
generate visualized log information for visualizing the log information based on the identified processing information;
assign, to the visualized log information, time interval information indicating a time interval to be visualized for each predetermined piece of the processing information; and
output the visualized log information to a display device based on the time interval information.

2. The information processing device according to claim 1,
wherein the hardware processor is configured to:
for each piece of the processing information, in a case where first information indicating an event that occurs instantaneously is included, assign, to the visualized log information, the time interval information indicating a time interval longer than a time during which the first information has occurred; and
for each piece of the processing information, in a case where second information indicating an event that continuously occurs is included, assign, to the visualized log information, the time interval information indicating a time interval during which the second information has occurred.

3. The information processing device according to claim 1,
wherein the hardware processor is configured to identify the processing information from the log information based on at least one of reference information including a reference character string related to processing of the software to be visualized, an output format of the log file, a file name of the log file, or a predetermined character string included in the log file.

4. The information processing device according to claim 3, wherein
the hardware processor is configured to:
add the identified processing information identified to the visualized log information; and
configured to output the visualized log information to the display device together with the processing information.

5. The information processing device according to claim 4,
wherein the visualized log information includes a state of the software and a text log.

6. The information processing device according to claim 1,
wherein the hardware processor is configured to output, corresponding to an input time input from a user, for each piece of the processing information, the visualized log information corresponding to the input time to the display device.

7. The information processing device according to claim 6,
wherein the hardware processor is configured to update a state of the software and a text log included in the visualized log information simultaneously corresponding to the input time.

8. An information processing method executed by an information processing device, the information processing method comprising:
identifying, from log information related to a plurality of log files, processing information of software indicated by each of the log files;
generating visualized log information for visualizing the log information based on the processing information having been identified;
assigning, to the visualized log information, time interval information indicating a time interval to be visualized for each predetermined piece of the processing information; and
outputting the visualized log information to a display device based on the time interval information.

9. A non-transitory computer-readable medium including programmed instructions that cause a computer to perform:
identifying, from log information related to a plurality of log files, processing information of software indicated by each of the log files;
generating visualized log information for visualizing the log information based on the processing information having been identified;
assigning, to the visualized log information, time interval information indicating a time interval to be visualized for each predetermined piece of the processing information; and
outputting the visualized log information to a display device based on the time interval information.
